(19) United States
(12) Patent Application Publication
(10) Pub. No.: US 2005/0042334 A1
(43) Pub. Date: Feb. 24, 2005

(54) Dry half-finished meal

(76) Inventors: Simone Maria Schleker, Neuburg (DE); Elmar Martin Schleker, Neuburg (DE)

Correspondence Address: HAHN LOESER & PARKS, LLP, One GOJO Plaza, Suite 300, AKRON, OH, 44311-1076, US

(21) Appl. No.: 10/501,849

(22) PCT Filed: Jan. 14, 2003
(86) PCT No.: PCT/EP03/00295

(30) Foreign Application Priority Data
Jan. 16, 2002 (DE) 10201377.2

(51) Int. Cl. C12C 1/027

(52) U.S. Cl. 426/106

(57) ABSTRACT

Disclosed is a dry, packaged half-finished meal in the form of a mixture of two separate batches. The first batch is treated in an aqueous phase while the second batch is treated in edible oil and/or fat. The second phase aromatizes the first phase after mixing thereof.

The invention relates to a dry semi-ready meal packaged ready for preparing a meal featuring high sensorial quality. It also relates to a method of preparing the same.

Dry semi-ready meals (termed DSR meals in the following) consist of mixtures of dry or dried ingredients cooked by the consumer with the addition of a liquid, usually water, including, where necessary, the addition of oil and/or fat for quick production of a meal. “Cooking” in the sense of the present invention is intended to cover all typical types of preparation including not only cooking but also baking, frying, fritting, boiling, steaming, grilling, roasting and braising.

DSR meals contain one or more typical staple ingredients. In the sense of the present invention, staple ingredients are understood to be foodstuffs having a physiological effect such as, e.g., pasta, rice, cereals, potatoes, meat, vegetables, eggs, bread, milk, fruit, in contrast to other ingredients that stimulate taste, smell, appetite and nourishment such as e.g. herbs and spices. In addition conventional DSR meals may also contain such food additives as e.g. anti-oxidants, binding agents, emulsifiers, colorants, taste intensifiers, preservatives, modified starches, acidifiers, acidic regulators, stabilizers, sweeteners and thickeners. Further, conventional DSR meals mostly contain solid fats and flavorings.

DSR meals are marketed packaged, containing all ingredients in a mixture as necessary for preparation in water. Also available are so-called “instant” semi-ready meals which are pre-prepared in combination with fresh ingredients. However, such state of the art DSR meals may contain substances, the beneficial use of which is extremely controversial in modern nutritional physiological views. For a food item to comply with the requirements of EU bio Directive No. 2092/91, German AGÖL, and/or Bioland and/or Demeter associations and/or of the International Federation of Organic Agricultural Movements (IFOAM) and/or German organic and health food marking requirements, it must not contain chemically prepared organically-identical or artificial flavorings, or food additives—(except those as listed in Attachment 1) or solid fats. The requirements of bio watchdog committees sometimes exceed EC directive 2092/91 by e.g.,. permitting the use of organic flavorings in food items verified by the association only when FTNF (From the Named Fruit) flavors. Because of DSR meals retailed by the food sector include flavorings, additives and solid fats, they are not recommended by modern nutritional advisory bodies.

Practically no DSR meals at all without these controversial ingredients are retailed in the food sector and only a few isolated products, e.g., instant soups or powdered potato meals, are offered in the organic and health food sector. DSR meals are primarily prepared at home. With the exception of powdered potato products, such DSR meals are not tasty. This being the reason why they are avoided by restaurants and organized catering services in business, schools and universities. Indeed, even eating places low on the scale of culinary excellence, such as rail and road fast food establishments usually make no use of DSR meals.

The invention is thus based on the object of making available DSR meals and a method for their preparation with which meals can now be prepared not only conveniently but also tasty to a degree as to now also find acceptance in restaurants and catering services while meeting modern advisory body requirements for healthy, balanced nutrition in keeping with pertinent national and international association standards.

It has been surprisingly discovered that meals of enhanced gustatorial and olfactory quality are now achievable by first dividing the mixture of dry or dried ingredients into a water phase and an oil phase before preparing the ready meal, particularly before cooking the staple ingredients. This is why for marketing such a DSR meal, the corresponding dispensed dry ingredients for a meal are now packaged in two separate batches.

The first batch is made up of the staple ingredients to be cooked in the water phase together with the spices and/or herbs and/or seasonings and/or additives for consistency. The second batch consists of one or more spices and/or herbs for dissolution in cooking oil and/or fat, and/or staple ingredients. Assigning the spices to the fat or water phase is such that temperature-sensitive spices and herbs, i.e., those which must not be boiled, are assigned to the water phase—these include sensitive herbs and spices, vanilla, citrus fruits, berries, dried fruit and vegetables—whereas all other spices and herbs (fruit, seed, flower, bark and root spices and robust herbs and oilseeds) which are not temperature-sensitive are assigned to the oil phase. An assignment of various spices and seasonings to the oil phase or water phase, intended, however, merely to assist orientation, is given in Table 1.

TABLE 1 (1)
Assignment of Spices or Seasonings to Water-Phase and/or Oil Phase

| spices and | | | plant part | | | suitability for | suitability for | pref. oil |
|---|---|---|---|---|---|---|---|---|
| seasonings | common name | botanic name | used | treated | form | water phase | oil phase | temperature |
| ajwain | Egyptian | Carum copticum, | seed | dried | whole | a | x | 170° C. |
| | caraway | Trachyspermum ammi | | | ground | a | x | 150° C. |
| anise | | Pimpinella anisum | seed | dried | whole | a | x | 160° C. |
| | | | | | ground | a | x | 140° C. |
| asafoetida | devil's dung | Ferula asafoetida | resin | dried | ground | n | x | 160° C. |
| basil | | Ocimum basilicum | leaf | dried | grated | x | b | |
| | | | | freeze- | cut | x | b | |
| | | | | dried | | | | |
| bear's garlic | | Allium ursinum | leaf | dried | cut | x | b | |
| | | | | freeze- | cut | x | b | |
| | | | | dried | | | | |
| enugreek | | Trigonella | seed | dried | whole | a | x | 160° C. |
| | | foenumgraecum | | | | | | |
| summer savory | | Satureja hortensis | leaf | dried | grated | x | b | |
| | | | | freeze- | cut | x | b | |
| | | | | dried | | | | |
| paprika powder | | Capsicum annuum, | fruit w/wo | dried | whole | a | x | 150° C. |
| | | Capsicum frutenscens | seed | | coarse | a | x | 140° C. |
| | | | | | ground | | | |
| | | | | | ground | a | x | 120° C. |
| | | | | freeze- | cut | x | b | |
| | | | | dried | | | | |
| | Turkish, | | | dried, | coarse | a | x | 150° C. |
| | paprika pepper | | | roasted | ground | | | |
| | | | | | ground | a | x | 140° C. |
| | Cayenne | | | dried | ground | x | b | |
| | pepper | | | | | | | |
| curry leaves | | Murraya koenigii | leaf | dried | whole | x | b | |
| | | | | | cut | x | b | |
| dill | | Anethum sowa, | seed | dried | whole | a | x | 160° C. |
| | | Anethum graveolens | | | ground | a | x | 140° C. |
| | dill tips | | leaf | dried | whole | x | n | |
| | | | | freeze- | cut | x | n | |
| | | | | dried | | | | |
| tarragon | | Artemisia dracunulus | leaf | dried | cut | x | n | |
| | | | | freeze- | cut | x | n | |
| | | | | dried | | | | |
| fennel | | Foeniculum vulgare | seed | dried | whole | a | x | 160° C. |
| | | | | | ground | a | b | |
| greater | | Alpina galanga | root | dried | ground | x | n | |
| galangal | | | | | | | | |
| pomegranate | | Punica granatum | seed with | dried | whole | x | n | |
| seeds | | | fruit pulp | | ground | x | n | |
| roselle | | Hibiscus sabdariffa | flower | dried | whole | x | n | |
| | | | | | cut | x | n | |
| ginger | | Zingiber officinalis | root | dried | cut | a | x | 150° C. |
| | | | | | ground | a | x | 140° C. |
| | | | | freeze- | cut | x | n | |
| | | | | dried | | | | |
| black cumin | kala jeera | Vernonia andhelmintica | seed | dried | whole | a | x | 140° C. |
| | | | | | ground | a | x | 130° C. |
| green | | Elettaria kardamomum | capsule w. | dried | whole | x | x | 170° C. |
| cardamom | | | seed | | ground | a | x | 140° C. |
| | | | seed | dried | whole | a | x | 160° C. |
| | | | | | ground | a | x | 140° C. |
| brown | | Amomum subulatum | capsule w. | dried | whole | a | — | |
| cardamom | | | seed | | | | | |
| chervil | | Anthriscus cerefolium | leaf | dried | grated | x | n | |
| | | | | freeze- | cut | x | n | |
| | | | | dried | | | | |
| garlic | | Allium sativum | | dried | ground | x | b | |
| | | | | | cut | x | b | |
| | | | | freeze- | cut | x | n | |
| | | | | dried | | | | |
| coriander | | Coriandrum sativum | seed | dried | whole | n | x | 160° C. |
| | | | | | coarse | a | x | 150° C. |
| | | | | | ground | | | |
| | | | | | ground | a | x | 140° C. |
| | | | leaf | dried | grated | x | n | |
| | | | | freeze- | cut | x | n | |
| | | | | dried | | | | |
| cumin | cumin | Cuminum cyminum | seed | dried | whole | a | x | 160° C. |
| | | | | | ground | a | x | 140° C. |
| caraway | | Carum carvi | seed | dried | whole | x | x | 140° C. |
| | | | | | ground | x | x | 130° C. |
| tumeric | yellow | Curcuma longa | root | dried | ground | x | x | 150° C. |
| lavender | | Lavendula officinalis | flower | dried | whole | x | n | |
| lemon grass | lemon grass | Cymbopogon citratus | leaf | dried | cut | x | n | |
| | | | | freeze- | cut | x | n | |
| | | | | dried | | | | |
| Lovage | Maggikraut | Levisticum officinale | leaf | dried | grated | x | b | |
| | | | | freeze- | cut | x | b | |
| | | | | dried | | | | |
| laurel | | Laurus nobilis, | leaf | dried | whole | x | x | 150° C. |
| | | Cinnamomum lamala, C. | | | cut | x | x | 150° C. |
| | | obtusufolium | | | ground | x | b | |
| marjoram | | Origanum majorana | leaf | dried | grated | x | b | |
| | | | | freeze- | cut | x | b | |
| | | | | dried | | | | |
| mango | | Mangifera indica | green fruit | dried | ground | x | n | |
| | | | pulp | | | | | |
| mint | peppermint | Mentha piperita | leaf | dried | grated | x | n | |
| | spearmint | Mentha spicata Mentha | | | | | | |
| | frizzy mint | crispa | | | | | | |
| | etc. | etc. | | | | | | |
| poppy | white | Papaver somniferum | seed | dried | ground | a | x | 150° C. |
| nutmeg | | Myristica fragans | flower | dried | ground | x | x | 140° C. |
| | | | nut | dried | ground | x | x | 120° C. |
| cloves | | Caryophyllus aromaticus | flower | dried | whole | a | x | 160° C. |
| | | | | | ground | a | x | 140° C. |
| orange | | Citrus sinensis | peel | dried | cut | x | n | |
| | | | | | ground | x | n | |
| oregano | | Origanum vulgare | leaf | dried | grated | x | b | |
| | | | | freeze- | cut | x | b | |
| | | | | dried | | | | |
| paprika | mild sweet | Capsicum annuum | fruit | dried | ground | x | x | 120° C. |
| | | | | | cut | a | x | 130° C. |
| | hot | | | dried | ground | x | x | 120° C. |
| | | | | | cut | a | x | 130° C. |
| parsley | | Petroselinum crispum | leaf | dried | grated | x | n | |
| | | | | freeze- | cut | x | n | |
| | | | | dried | | | | |
| pepper | green | Piper nigrum | berries | dried | whole | x | n | |
| | | | | freeze- | whole | x | n | |
| | | | | dried | | | | |
| | black | | | dried | whole | x | x | 160° C. |
| | | | | | coarse | x | x | 150° C. |
| | | | | | ground | | | |
| | | | | | ground | x | x | 140° C. |
| | | | | freeze- | whole | x | b | |
| | | | | dried | coarse | x | b | |
| | | | | | ground | | | |
| | white | | | dried | whole | x | x | 150° C. |
| | | | | | coarse | x | x | 140° C. |
| | | | | | ground | | | |
| | | | | | ground | x | x | 130° C. |
| | | | | freeze- | whole | x | b | |
| | | | | dried | coarse | x | b | |
| | | | | | ground | | | |
| pepper | rose | Schinus molle | berries | dried | whole | x | n | |
| pimenta | clove pepper | Pimenta officinalis | berry | dried | whole | x | x | 150° C. |
| | | kannada | | | ground | x | x | 140° C. |
| rosemary | | Rosmarinus officinalis | leaf | dried | cut | x | b | |
| | | | | freeze- | whole | x | b | |
| | | | | dried | cut | x | b | |
| saffron | | Crocus sativus | stigma | dried | whole | x | n | |
| | | | | | ground | x | n | |
| sage | | Salvia officinalis | leaf | dried | cut | x | b | |
| | | | | freeze- | cut | x | b | |
| | | | | dried | | | | |
| sandalwood | | Santalum album | wood | dried | ground | x | — | |
| chives | | | leaf | dried | cut | x | n | |
| | | | | freeze- | cut | x | n | |
| | | | | dried | | | | |
| black cumin | | Nigella sativa | seed | dried | whole | x | x | 150° C. |
| | | | | | ground | x | x | 130° C. |
| celery | | | seed | dried | whole | a | x | 160° C. |
| | | | | | ground | a | x | 140° C. |
| mustard | yellow | Sinapis alba | seed | dried | whole | x | n | |
| | | | | | ground | x | n | |
| mustard | brown or black | Brassica juncea, | seed | dried | whole | a | x | 170° C. |
| | | Brassica nigra | | | ground | x | x | 150° C. |
| star anise | | Illicium verum | fruit with | dried | whole | x | x | 160° C. |
| | | | seed | dried | ground | x | x | 140° C. |
| thyme | | Thymus vulgaris | leaf | dried | grated | x | b | |
| | | | | freeze- | cut | x | b | |
| | | | | dried | | | | |
| vanilla | | Vanilla planifolia | fruit | dried | ground | x | n | |
| juniper | | Juniperus communis | berry | dried | whole | x | b | |
| | | | | | ground | x | b | |
| cinammon | Ceylon | Cinnamonum zeylanicum | bark | dried | whole | a | x | 170° C. |
| | cinammon | | | | cut | a | x | 160° C. |
| | | | | | ground | a | x | 150° C. |
| cinammon | cassia | Cinnamonum cassia | bark | dried | cut | a | x | 160° C. |
| | | | | | ground | a | x | 150° C. |
| lemon | | Citrus limon | peel | dried | cut | x | n | |
| | | | | | ground | x | n | |
| berries | strawberry | Fragaria ananassa | berry | dried | | x | n | |
| | raspberry | Rubus idaeus | | or | | | | |
| | currants | Ribes rubrum (nigrum) | | freeze- | | | | |
| | tomato | Lycopersicon esculentum | | dried | | | | |
| | etc. | | | | | | | |
| oil seeds | sesame | Sesamum indicum | seed | dried | | x | x | 140° C. |
| | sunflower | Helianthus annuus | | | | | | |
| | pumpkin seeds | Cucurbita | | | | | | |
| | poppy | Papaver somniferum | | | | | | |
| | etc. | | | | | | | |
| dried fruit | apples | Pyrus malus | fruit | dried | | x | n | |
| | banana | Musaceae | | | | | | |
| | apricots | Prunus aemeniaca | | | | | | |
| | dates | Phoenix avium | | | | | | |
| | figs | Ficus carica | | | | | | |
| | cherries | Prunus domestica | | | | | | |
| | currants | Vitis vinifera Agyrena | | | | | | |
| | prunes | Prunus domestica | | | | | | |
| | raisins | Vitis vinifera | | | | | | |
| | morellos | Prunus cerasus | | | | | | |
| | sultanas | Vitis vinifera | | | | | | |
| | grapes | Vitis vinifera | | | | | | |
| | etc. | | | | | | | |
| dried | carrots | Daucus carota | leaf, root | dried | | x | n | |
| vegetables | leek | Allium porrum | | or | | | | |
| | parsnip | Pastinaca sativa | | freeze- | | | | |
| | onions | Allium cepa | | dried | | | | |
| | shallots | Allium ascalonicum | | or | | | | |
| | parsley | Petroselinum crispum | | spray- | | | | |
| | onions | Allium cepa | | dried | | | | |
| | etc. | | | | | | | |
| other spices | meat and meat | | | dried | | x | n | |
| and seasonings | extract | | | or | | | | |
| | fish and fish | | | freeze- | | | | |
| | extract | | | dried | | | | |
| | cheese | | | or | | | | |
| | yeast | | | spray- | | | | |
| | soy sauce | | | dried | | | | |
| | dairy products | | | | | | | |
| | etc. | | | | | | | |
| dried | yellow boletus | Boletus edulis, | head and | dried | whole | x | b | |
| mushrooms | chanterelle | B. pinicola, | stalk | or | cut | | | |
| | mushroom | B. aereus, | | freeze- | ground | | | |
| | oyster | B. aestivalis | | dried | | | | |
| | mushroom | Cantharellus cibarius | | | | | | |
| | shiitake | Agaricus arvensis, | | | | | | |
| | mushroom | A. silvatica, | | | | | | |
| | | A. campestris, | | | | | | |
| | | A. bispora | | | | | | |
| | | Pleurotus ostreatus | | | | | | |
| | | Lentinus edodes | | | | | | |

Legend:
x = suitable
n = not suitable
a = relatively suitable (better result when assigned to fat phase)
b = relatively suitable (temperature-sensitive)
— = no use known

Since with spices and herbs, the temperature for optimum release of taste in the oil phase depends on their degree of size reduction in each case (e.g., a higher oil temperature being required for whole spices than when finely ground) in a combination of herbs and spices their degree of size reduction (whole—coarse—fine) needs to be adapted individually so that optimum release of taste occurs in each case at the same oil temperature, where possible.

When heating the oil phase, the ingredients dissolving in fat define the characteristic taste of the meal in each case, especially from their essential oils and/or hot pungent substances (including, among others, piperine, capsaicin, mustard oils, allilne) passing into the cooking oil and/or fat in flavoring it. Where necessary, fresh ingredients, especially the staple ingredients, but also herbs and/or vegetables may be added to a ready dry mixture. If these are not temperature-sensitive and can be assigned to the oil phase, they may be coated with flavored oil.

In the water phase, the staple ingredients are cooked and spices and/or herbs are absorbed along with such taste and smell enhancing ingredients (essential oils, bitters, hot pungent substances) that on mixing with the flavored oil phase of the meal being prepared, in each case create the desired typical gustatorial and olfactory overall impact by enhancing the inherent taste and smell of the staple ingredients.

The spices and/or herbs for absorption in the oil phase are mixed and heated by the consumer with cooking oil and/or fat available at home. The spices and/or herbs may be mixed with the oil and/or fat prior to heating or the oil and/or fat may be first heated and then the spices and/or herbs added. By the essential oils dissolving in the fat and the hot pungent ingredients passing into the oil and/or fat, the latter is flavored. This action is complete as soon as the flavorings dissolved in the oil and/or fat release a perceptible aroma either as key components or as an impact compound.

A volatile compound is termed an impact compound when it alone produces the typical flavor impact of a spice, whereas when several separate compounds are responsible therefor, they are termed key components.

If only spices and/or herbs are sauteed, just a few seconds in hot oil and/or fat are sufficient at a temperature in the range 120° C. to 170° C. If fresh staple ingredients are sauteed, 30 secs. to 5 minutes are sufficient. There is no need for the oil/fat temperature to be measured in preparation, actual kitchen practice has shown that it is sufficient to take care that the spices and/or herbs are dearly perceptible by smell and the mixture is not overheated (to more than 180° C.). Allowing the oil and/or fat to smoke or even boil must be avoided. This can result in unhealthy trans fatty acids, undesirable roasted substances with the danger of oil and/or fat spattering on when adding water.

All other ingredients, particularly the staple ingredients are mixed with water and cooked in the aqueous phase. The water phase is added to the flavored oil and/or fat. Mixing of the remaining ingredients with water can be done prior to adding the water phase to the flavored oil phase. Or a metered amount of water is added to the flavored oil phase before adding the remaining ingredients. The meal is then cooked until the staple ingredients are done.

Flavoring the cooking oil and/or fat as the first step is suitable for most recipes. Following release of the ingredients broken down in the oil phase, cooking up to 10 minutes in water will not produce any further tangible change in the degree of extraction of the inherent fat soluble essential oils and/or hot pungent substances.

Where meals are concerned having staple ingredients that need to be cooked longer in the water phase, such as legumes, whole-meal wheat, brown rice, it may be advantageous to first cook them in the water phase together with the further ingredients for the water phase and to add the flavored oil phase when done. This prevents bitters and other substances affecting the taste and/or smell contained in the ingredients for the oil phase or formed in lengthy cooking from passing into the water phase during cooking. Following the addition of the flavored oil phase when done, the meal is then left to stand for a further 5 minutes or so for an intimate intermingling of aromas and flavorings.

Since in accordance with the invention the spice and/or herb mixture for breakdown in the oil phase are packaged separate from the staple ingredients to be cooked in the water phase, the producer of the DSR meals in accordance with the invention has the possibility of offering the oil phase already flavored with the spice and/or herb mixture apportioned for a specific meal separately packaged. The flavored oil in a suitable package then merely needs to be added to the remaining ingredients at the desired point in time.

Suitable for this purpose is, e.g., a plastic-finished bag of aluminum foil as used for apportioned packs of ketchup or mustard, or a glass vial as usual for bakery flavorings. Also suitable are one or more gelatin or starch capsules as usual for swallowing medicines and that have the advantage that they dissolve on cooking in adding body to the meal. Likewise suitable is a herbal drop containing a filling of spice and/or herbal extracts, or a closed salt crystal likewise containing a filling of spice and/or herbal extracts which have the advantage of dissolving on cooking in making use of the sugar or salt shell for flavoring the meal.

The method in accordance with the invention for the preparation of meals from the DSR meals in accordance with the invention now makes it possible to produce DSR meals with the total elimination of all and any controversial, undesirable, particular chemically modified food additives while nevertheless preparing a meal that in its overall sensorial impact and from a nutritional physiological point of view is practically identical to that of a meal prepared with fresh ingredients. In addition, the labor in developing recipes is relatively low as compared to that of conventional DSR meals since recourse can now be made to traditional cooking recipes having a proven record of success. This is why meals prepared with DSR ingredients in accordance with the invention satisfy the culinary requirements of high-profile catering establishments or restaurants while complying with EU bio directive (EEC Directive No. 2092/91) and organic and/or health food guideline requirements. When dispensing with compliance with such requirements, then instead of flavored cooking oil, flavored or plain solid fat may be employed. This still allows meals to be prepared with a convincing taste and, in this case, there is no need for separate packaging.

The invention will now be detailed by way of the following examples:

### EXAMPLE 1

Red Lentils with Spices (Bengali Masar Dal)

The composition of the (dried) staple ingredients and spices of the first separate packaged batch for cooking in water is as follows:

| | | |
|---|---|---|
| Red lentils (masar dal) | 225 | g |
| Tomato powder (spray dried) | 12 | g |
| Salt | 8.25 | g |
| Cane sugar | 0.5 | g |
| Paprika, hot, ground | 1.7 | g |
| Paprika, mild sweet, ground | 1.4 | g |
| Ginger, ground | 1 | g |
| Tumeric, ground | 0.65 | g |
| Garlic, freeze-dried | 0.75 | g |
| Onions, freeze-dried | 0.55 | g |
| Parsley, freeze-dried | 0.32 | g |
| Bay-leaf | ½ | piece |

The composition of the spices and/or herbs of the second batch packaged separate for absorption in cooking oil is as follows:

| | |
|---|---|
| Cumin, whole | 0.9 g |
| Fennel, whole | 0.9 g |
| Black mustard, whole | 0.9 g |
| Black cumin, whole | 0.45 g |
| Fenugreek, whole | 0.45 g |
| Cinnamon pieces | 0.25 g |

The spice mixture of the second batch for the oil phase is added to two tablespoonfuls of cooking oil and heated; optionally the two tablespoonfuls of cooking oil are first heated and then the spice mixture added. Heat is applied until the spices release their odor, then 780 ml of water is added to the hot flavored oil phase. Then, the mixture of the first batch with the staple ingredients is added, stirred, brought to boil and left to simmer for 20 minutes with occasional stirring.

Since the staple ingredient is a legume requiring a somewhat longer cooking time, in a preferred embodiment, the first batch for the water phase is first boiled in water for a period of 15 minutes before adding the flavored oil phase and leaving to simmer for further 5 minutes.

### EXAMPLE 2

Fine Basmati Rice (Paliala Pilaw)

The composition of the (dried) staple ingredients and spices of the first separate packaged batch for cooking in water is as follows:

| | | |
|---|---|---|
| Basmati rice | 225 | g |
| Salt | 8.25 | g |
| Cane sugar | 0.5 | g |
| Onions, freeze-dried | 1.1 | g |
| Tumeric, ground | 0.65 | g |
| Garlic, freeze-dried | 0.75 | g |
| Bay-leaf | ½ | piece |

The composition of the spices and/or herbs of the second batch packaged separate for absorption in cooking oil is as follows:

| | | |
|---|---|---|
| Cumin | 0.3 | g |
| Cloves | 4 | pieces |
| Cinnamon stick | 3 | cm |
| Green cardamom, whole capsules | 4 | pieces |

Two tablespoonfuls of cooking oil are added to the spice mixture of the second batch for the oil phase and heated; optionally the two tablespoonfuls of cooking oil are first heated and then the spice mixture added. Heat is applied until the spices release their odor, then 620 ml of water is added to the hot flavored oil phase. Then, the rice mixture is added, stirred, brought to boil and left to simmer for 10 minutes with the lid on. This is followed by leaving to finish for a further 10 minutes on a low flame before the meal is removed from the flame, left to stand for 5 minutes and fluffed with a fork.

For makers of DSR meals in accordance with the invention there is now the possibility of developing new ranges of products to advantage as were formerly hardly achievable with conventional DSR meals.
Restaurant owners hitherto unable to offer higher quality vegetarian food can now offer instant vegetarian dishes.
Catering services can now install vending machines for obtaining meals of high nutritional physiological value.
Relatively unknown, but good-tasting legumes of high nutritional physiological value (French green lentils, belugal lentils, champagne lentils, mountain lentils, toor dal peas, channa dal peas, azuiki beans, pinto beans and a whole lot more) can now be packaged as DSR meals together with suitable spices and/or herbs.
New fillers of cooked varieties of cereals (spelt, kamut, barley, oats, green core, wheat) or unusual varieties (amaranth, buckwheat, barley, millet, maize, quinoa) can now be packaged together with suitable spices and/or herbs for appropriately extending dishes on offer in also rendering them to full value nutritionally.
Classical international dishes requiring sophisticated spices normally not available as household spices can now be prepared more conveniently and with more certainty.
Soy extrudate meat-replacement meals are now achieved as DSR meals.
DSR meals suitable for diet schedules can now be developed, necessary e.g. with such afflictions as diabetes mellitus, hypercholestereinemia, hypertriglyceridemia, hypertonia, gout, coeliac/celiac disease.
DSR recipes can now be adjusted to meet the particular nutritional needs as medically recommended for such groups as active sports enthusiasts and professionals, expectant and nursing mothers, vegetarians requiring a special or enhanced intake of specific amino acids, vitamins and minerals.
DSR based ayurvedic recipes can now be made available.

1-14. (cancelled).

15. A dry, packaged semi-ready meal for preparing a meal of high gustatorial quality comprising:
a mixture of dry and dried ingredients provided in two batches packaged separate from each other;
the first batch comprising dried temperature-sensitive ingredients to be cooked and/or absorbed in an aqueous solution; and
the second batch comprising temperature-insensitive ingredients to be absorbed in cooking oil and/or fat, whose fat-dissolving ingredients flavor the cooking oil and/or fat, and which,
after mixing same with the first batch in the aqueous solution in combination with the inherent taste and odor of staple ingredients and the gustatorial and olfactory ingredients of the first batch, endow the meal to be prepared after cooking with its typical overall gustatorial and olfactory impact.

16. The dry, packaged semi-ready meal according to claim 15, wherein staple ingredients in dried form are contained in the separately packaged first batch with the dried temperature-sensitive ingredients comprising at least one of spices, herbs, seasonings, consistency-enhancing ingredients, or additives.

17. The dry, packaged semi-ready meal according to claim 16, wherein the temperature-insensitive ingredients comprise at least one of herbs and spices; and said at least one of herbs and spices are ground to a degree relative to each other so that optimum release of each gustatorial component of said at least one of herbs and spices occurs at about the same oil temperature.

18. The dry, packaged semi-ready meal according to claim 15, wherein the temperature-insensitive ingredients comprise at least one of herbs and spices; and said at least one of herbs and spices are ground to a degree relative to each other so that optimum release of each gustatorial component of said at least one of herbs and spices occurs at about the same oil temperature.

19. The dry, packaged semi-ready meal according to claim 15, wherein the staple ingredients include at least one of legumes, rice, pasta, cereals, and soy extrudate.

20. A method of preparing a meal from a dried semi-ready meal according to claim 1 comprising the steps:
flavoring cooking oil and/or fat with the temperature-insensitive ingredients of the second batch by heating,
absorbing the temperature-sensitive ingredients contained in the first batch together with the staple ingredients to be cooked in the aqueous solution, and
mixing the aqueous solution with the flavored cooking oil and/or fat.

21. The method according to 20, wherein the step of mixing the aqueous solution with the flavored cooking oil and/or fat is done after cooking the staple ingredients in the aqueous phase.

22. The method according to claim 20, wherein the step of mixing the aqueous phase with the flavored cooking oil and/or fat is done before cooking the staple ingredients.

23. The method according to claim 20, further comprising:
coating and/or searing fresh staple ingredients with the flavored cooking oil and/or fat before being mixed and cooked with the ingredients of the first batch in the aqueous solution.

24. The method according to claim 20, wherein the cooking oil and/or fat is heated for flavoring with the ingredients of the second batch to a temperature in the range 120° C. to 170° C.

25. Use of a dried, packaged semi-ready meal according to claim 1 to prepare a meal for sale in vending machines.

26. A dry, packaged semi-ready meal for preparing a meal of high gustatorial quality comprising:
a mixture of dry and dried ingredients provided in a first batch and a second batch, the first and second batches being packaged separate from one another,
the first batch comprising temperature-sensitive ingredients to be cooked and/or absorbed in an aqueous solution,
the second batch comprising temperature-insensitive fat soluble ingredients to be absorbed in cooking oil and/or fat,
at least one of the first batch and the second batch further comprising staple ingredients,
wherein after mixing the first batch and aqueous phase with the second batch, the mixed batches provide the meal to be prepared, after cooking, with its typical overall gustatorial and olfactory impact.

27. The dry, packaged semi-ready meal according to claim 26, wherein the staple ingredients in dried form are contained in the separately packaged first batch with the dried temperature-sensitive ingredients comprising at least one of spices, herbs, seasonings, consistency-enhancing ingredients, or additives.

28. The dry, packaged semi-ready meal according to claim 27, wherein the temperature-insensitive fat soluble ingredients comprise at least one of herbs and spices; and said at least one of herbs and spices are ground to a degree relative to each other so that optimum release of each gustatorial component of each of said at least one of herbs and spices occurs at about the same oil temperature.

29. The dry, packaged semi-ready meal according to claim 26, wherein the temperature-insensitive fat soluble ingredients comprise at least one of herbs and spices; and said at least one of herbs and spices are ground to a degree relative to each other so that optimum release of each gustatorial component of each of said at least one of herbs and spices occurs at about the same oil temperature.

30. The dry, packaged semi-ready meal according to claim 26, wherein the staple ingredients include at least one of legumes, rice, pasta, cereals, and soy extrudate.

31. A method of preparing a meal of high gustatorial quality comprising the steps of:
providing a dry, packaged semi-ready meal for preparing the meal of high gustatorial quality comprising:
a mixture of dry and dried ingredients provided in a first batch and a second batch, the first and second batches being packaged separate from one another,
the first batch comprising temperature-sensitive ingredients to be cooked and/or absorbed in an aqueous solution,
the second batch comprising temperature-insensitive fat soluble ingredients to be absorbed in cooking oil and/or fat,
at least one of the first batch and the second batch further comprising staple ingredients,
adding the first batch temperature-sensitive ingredients to an aqueous solution;
heating the aqueous solution to absorb the temperature-sensitive-ingredients into the aqueous solution and cooking any staple ingredients included with the first batch;
adding the second batch temperature-insensitive fat soluble ingredients to cooking oil and/or fat;
heating the cooking oil and/or fat until the cooking oil and/or fat are flavored by the second batch temperature-insensitive fat soluble ingredients; and
mixing the aqueous solution and temperature-sensitive ingredients with the flavored cooking oil and/or fat.

32. The method according to 31, wherein the step of mixing the aqueous solution and temperature-sensitive ingredients with the flavored cooking oil and/or fat is done after cooking the staple ingredients in the aqueous phase.

33. The method according to claim 31, wherein the step of mixing the aqueous solution and temperature-sensitive ingredients with the flavored cooking oil and/or fat is done before cooking the staple ingredients.

34. The method according to claim 31, further comprising:
coating and/or searing fresh staple ingredients with the flavored cooking oil and/or fat before the step of mixing the aqueous solution and temperature-sensitive-ingredients with the flavored cooking oil and/or fat.
